(19) United States
(12) Patent Application Publication
(10) Pub. No.: US 2009/0325845 A1
(43) Pub. Date: Dec. 31, 2009

(54) Low-Built, Anionic Detersive Surfactant-Containing Solid Laundry Detergent Compositions that Additionally Comprises Clay

(76) Inventors: Hossam Hassan Tantawy, Northumberland (GB); Andrew Brian Greenaway Patton, Newcastle Upon Tyne (GB)

Correspondence Address: THE PROCTER & GAMBLE COMPANY;Global Legal Department - IP, Sycamore Building - 4th Floor, 299 East Sixth Street, CINCINNATI, OH, 45202, US

(21) Appl. No.: 12/483,277

(22) Filed: Jun. 12, 2009

(30) Foreign Application Priority Data
Jun. 25, 2008 (EP) 08 159 015.0

(51) Int. Cl. C11D 3/08

(52) U.S. Cl. 510/276

(57) ABSTRACT

The present invention relates to a solid laundry detergent composition comprising: (a) anionic detersive surfactant; (b) from 0 wt % to 10 wt % zeolite builder; (c) from 0 wt % to 10 wt % phosphate builder; (d) at least 2 wt % water; (e) clay; and (f) optionally from 0 wt % to 20 wt % silicate salt, wherein the clay is in non-spray-dried form, and wherein at least part of the anionic detersive surfactant is in spray-dried form.

### FIELD OF THE INVENTION

The present invention relates to solid laundry detergent compositions comprising clay. The solid laundry detergent composition comprises anionic detersive surfactant, is low built, and additionally comprises clay. The clay is non-spray-dried form.

### BACKGROUND OF THE INVENTION

There is a recent trend in the laundry detergent industry to produce low-built laundry powders. Additionally, there is a trend in the laundry detergent industry to produce more compact product forms. There is a continuing need for a low-built, compacted laundry detergent powder that exhibits improved stability, improved processability and has an improved environmental profile.

The Inventors have overcome this problem by introducing clay in non-spray dried form into a low-built solid laundry detergent composition. The Inventors have found that the introduction of clay in non-spray dried form allows for a greater powder density range to be achieved, improves the environmental profile and improves the stability profile of the solid laundry detergent composition.

### SUMMARY OF THE INVENTION

The present invention relates to a solid laundry detergent composition as defined by claim 1.

### DETAILED DESCRIPTION OF THE INVENTION

### Solid Laundry Detergent Composition

The solid laundry detergent composition comprises: (a) anionic detersive surfactant; (b) from 0 wt % to 10 wt % zeolite builder; (c) from 0 wt % to 10 wt % phosphate builder; (d) at least 2 wt % water; (e) clay; and (f) optionally from 0 wt % to 20 wt % silicate salt. The clay is in non-spray-dried form. At least part of the anionic detersive surfactant is in spray-dried form.

Preferably, the composition comprises from 3 wt %, or from 4 wt %, or from 5 wt %, or from 6 wt %, or from 7 wt %, or from 8 wt %, or from 9 wt %, or even from 10 wt % water.

Preferably, the composition comprises smectite clay, preferably dioctahedral smectite clay, preferably montmorillonite clay.

Preferably, the composition comprises from 0.1 wt % to 30 wt % clay, preferably from 1 wt %, or from 2 wt %, or from 3 wt %, or from 4 wt % clay, and preferably to 25 wt %, or to 20 wt %, or to 15 wt %,or to 10 wt % clay.

Preferably, the composition comprises: (a) spray-dried powder comprising: (i) anionic detersive surfactant; (ii) from 0 wt % to 10 wt % zeolite builder; (iii) from 0 wt % to 10 wt % phosphate builder; and (iv) optionally from 0 wt % to 20 wt % silicate salt; and (b) non-spray-dried powder comprising clay.

The composition is a fully formulated laundry detergent composition, typically comprising a plurality of chemically different particle populations such as spray-dried powder, dry-added clay particles, and other particles such as surfactant agglomerates, dry-added percarbonate particles, perfume microcapsule particles, and perfume starch encapsulates.

### Anionic Detersive Surfactant

The anionic detersive surfactant preferably comprises alkyl benzene sulphonate. Preferably the anionic detersive surfactant comprises at least 50%, preferably at least 55%, or at least 60%, or at least 65%, or at least 70%, or even at least 75%, by weight of the anionic detersive surfactant, of alkyl benzene sulphonate. Preferably the alkyl benzene sulphonate is a linear or branched, substituted or unsubstituted, C₈₋₁₈ alkyl benzene sulphonate. This is the optimal level of the C₈₋₁₈ alkyl benzene sulphonate to provide a good cleaning performance. The C₈₋₁₈ alkyl benzene sulphonate can be a modified alkylbenzene sulphonate (MLAS) as described in more detail in WO 99/05243, WO 99/05242, WO 99/05244, WO 99/05082, WO 99/05084, WO 99/05241, WO 99/07656, WO 00/23549, and WO 00/23548. Highly preferred C₈₋₁₈ alkyl benzene sulphonates are linear C₁₀₋₁₃ alkylbenzene sulphonates. Especially preferred are linear C₁₀₋₁₃ alkylbenzene sulphonates that are obtainable, preferably obtained, by sulphonating commercially available linear alkyl benzenes (LAB); suitable LAB include low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®.

The anionic detersive surfactant may preferably comprise other anionic detersive surfactants. A preferred adjunct anionic detersive surfactant is a non-alkoxylated anionic detersive surfactant. The non-alkoxylated anionic detersive surfactant can be an alkyl sulphate, an alkyl phosphate, an alkyl phosphonate, an alkyl carboxylate or any mixture thereof. The non-alkoxylated anionic surfactant can be selected from the group consisting of; C₁₀-C₂₀ primary, branched-chain, linear-chain and random-chain alkyl sulphates (AS), typically having the following formula:

CH₃(CH₂)ₓCH₂—OSO₃⁻M⁺

wherein, M is hydrogen or a cation which provides charge neutrality, preferred cations are sodium and ammonium cations, wherein x is an integer of at least 7, preferably at least 9; C₁₀-C₁₈ secondary (2,3) alkyl sulphates, typically having the following formulae:

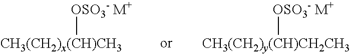

wherein, M is hydrogen or a cation which provides charge neutrality, preferred cations include sodium and ammonium cations, wherein x is an integer of at least 7, preferably at least 9, y is an integer of at least 8, preferably at least 9; C₁₀-C₁₈ alkyl carboxylates; mid-chain branched alkyl sulphates as described in more detail in U.S. Pat. No. 6,020,303 and U.S. Pat. No. 6,060,443; methyl ester sulphonate (MES); alpha-olefin sulphonate (AOS); and mixtures thereof.

Another preferred anionic detersive surfactant is an alkoxylated anionic detersive surfactant. The presence of an alkoxylated anionic detersive surfactant in the spray-dried powder provides good greasy soil cleaning performance, gives a good sudsing profile, and improves the hardness tolerance of the anionic detersive surfactant system. It may be preferred for the anionic detersive surfactant to comprise from 1% to 50%, or from 5%, or from 10%, or from 15%, or from 20%, and to 45%, or to 40%, or to 35%, or to 30%, by weight of the anionic detersive surfactant system, of an alkoxylated anionic detersive surfactant.

Preferably, the alkoxylated anionic detersive surfactant is a linear or branched, substituted or unsubstituted C₁₂₋₁₈ alkyl alkoxylated sulphate having an average degree of alkoxylation of from 1 to 30, preferably from 1 to 10. Preferably, the alkoxylated anionic detersive surfactant is a linear or branched, substituted or unsubstituted C₁₂₋₁₈ alkyl ethoxylated sulphate having an average degree of ethoxylation of from 1 to 10. Most preferably, the alkoxylated anionic detersive surfactant is a linear unsubstituted C₁₂₋₁₈ alkyl ethoxylated sulphate having an average degree of ethoxylation of from 3 to 7.

The alkoxylated anionic detersive surfactant, when present with an alkyl benzene sulphonate may also increase the activity of the alkyl benzene sulphonate by making the alkyl benzene sulphonate less likely to precipitate out of solution in the presence of free calcium cations. Preferably, the weight ratio of the alkyl benzene sulphonate to the alkoxylated anionic detersive surfactant is in the range of from 1:1 to less than 5:1, or to less than 3:1, or to less than 1.7:1, or even less than 1.5:1. This ratio gives optimal whiteness maintenance performance combined with a good hardness tolerance profile and a good sudsing profile. However, it may be preferred that the weight ratio of the alkyl benzene sulphonate to the alkoxylated anionic detersive surfactant is greater than 5:1, or greater than 6:1, or greater than 7:1, or even greater than 10:1. This ratio gives optimal greasy soil cleaning performance combined with a good hardness tolerance profile, and a good sudsing profile.

Suitable alkoxylated anionic detersive surfactants are: Texapan LEST™ by Cognis; Cosmacol AES™ by Sasol; BES151™ by Stephan; Empicol ESC70/™; and mixtures thereof.

Preferably, the anionic detersive surfactant comprises from 0% to 10%, preferably to 8%, or to 6%, or to 4%, or to 2%, or even to 1%, by weight of the anionic detersive surfactant, of unsaturated anionic detersive surfactants such as alpha-olefin sulphonate. Preferably the anionic detersive surfactant is essentially free of unsaturated anionic detersive surfactants such as alpha-olefin sulphonate. By “essentially free of” it is typically meant “comprises no deliberately added”. Without wishing to be bound by theory, it is believed that these levels of unsaturated anionic detersive surfactants such as alpha-olefin sulphonate ensure that the anionic detersive surfactant is bleach compatible.

Preferably, the anionic detersive surfactant comprises from 0% to 10%, preferably to 8%, or to 6%, or to 4%, or to 2%, or even to 1%, by weight of alkyl sulphate. Preferably the anionic detersive surfactant is essentially free of alkyl sulphate. Without wishing to be bound by theory, it is believed that these levels of alkyl sulphate ensure that the anionic detersive surfactant is hardness tolerant.

At least part of the anionic detersive surfactant is in the form of a spray-dried powder. However, some of the anionic detersive surfactant may in non-spray-dried form, such as in the form of an agglomerate. Alternatively, essentially all of the anionic detersive surfactant is in spray-dried form.

### Zeolite Builder

The composition typically comprises from 0% to 10 wt % zeolite builder, preferably to 9 wt %, or to 8 wt %, or to 7 wt %, or to 6 wt %, or to 5 wt %, or to 4 wt %, or to 3 wt %, or to 2 wt %, or to 1 wt %, or to less than 1% by weight of the composition, of zeolite builder. It may even be preferred for the composition to be essentially free from zeolite builder. By essentially free from zeolite builder it is typically meant that the composition comprises no deliberately added zeolite builder. This is especially preferred if it is desirable for the composition to be very highly soluble, to minimise the amount of water-insoluble residues (for example, which may deposit on fabric surfaces), and also when it is highly desirable to have transparent wash liquor. Zeolite builders include zeolite A, zeolite X, zeolite P and zeolite MAP.

### Phosphate Builder

The composition typically comprises from 0% to 10 wt % phosphate builder, preferably to 9 wt %, or to 8 wt %, or to 7 wt %, or to 6 wt %, or to 5 wt %, or to 4 wt %, or to 3 wt %, or to 2 wt %, or to lwt %, or to less than 1% by weight of the composition, of phosphate builder. It may even be preferred for the composition to be essentially free from phosphate builder. By essentially free from phosphate builder it is typically meant that the composition comprises no deliberately added phosphate builder. This is especially preferred if it is desirable for the composition to have a very good environmental profile. Phosphate builders include sodium tripolyphosphate.

### Clay

Typically, the clay is selected from the group consisting of: allophane clays; chlorite clays, preferred chlorite clays are amesite clays, baileychlore clays, chamosite clays, clinochlore clays, cookeite clays, corundophite clays, daphnite clays, delessite clays, gonyerite clays, nimite clays, odinite clays, orthochamosite clays, pannantite clays, penninite clays, rhipidolite clays, sudoite clays and thuringite clays; illite clays; inter-stratified clays; iron oxyhydroxide clays, preferred iron oxyhydoxide clays are hematite clays, goethite clays, lepidocrite clays and ferrihydrite clays; kaolin clays, preferred kaolin clays are kaolinite clays, halloysite clays, dickite clays, nacrite clays and hisingerite clays; smectite clays; vermiculite clays; and mixtures thereof.

Preferably, the clay is a smectite clay. Preferred smectite clays are beidellite clays, hectorite clays, laponite clays, montmorillonite clays, nontonite clays, saponite clays and mixtures thereof. Preferably, the smectite clay may be a dioctahedral smectite clay. A preferred dioctahedral smectite clay is montmorillonite clay. The montmorillonite clay may be low-charge montmorillonite clay (also known as sodium montmorillonite clay or Wyoming-type montmorillonite clay). Typically, low-charge montmorillonite clay can be represented by the formula:

NaxAl2-xMgxSi4O10(OH)2,

wherein, x is a number from 0.1 to 0.5, preferably from 0.2, and preferably to 0.4.

The montmorillonite clay may also be a high-charge montmorillonite clay (also known as a calcium montmorillonite clay or Cheto-type montmorillonite clay). Typically, high-charge montmorillonite clays can be represented by the formula:

CaxAl2-xMgxSi4O10(OH)2,

wherein, x is a number from 0.1 to 0.5, preferably from 0.2, and preferably to 0.4.

Preferably, the smectite clay is a trioctahedral smectite clay. A preferred trioctahedral smectite clay is hectorite clay. Typically, hectorite clay can be represented by the following formula:

[(Mg3-xLix)Si4-yMeIIIyO10(OH2-zFz)]−(x+y)((x+y)/n)Mn+,

wherein: y=0 to 0.4, if y=>0 then MeIII is AL, Fe or B, preferably y=0; and n is 1 or 2; and Mn+ is a monovalent (n=1) or a divalent (n=2) metal ion, preferably Mn+ is selected from the group Na, K, Mg, Ca and Sr; and x is a number from 0.1 to 0.5, preferably from 0.2, or from 0.25, and preferably to 0.4, or to 0.35; and z is a number form 0 to 2; and the value of x+y is the layer charge of the hectorite clay, preferably the value of x+y is from 0.1 to 0.5, preferably from 0.2, or from 0.25, and preferably to 0.4 or to 0.35.

Preferred hectorite clays have a cationic exchange capacity of at least 90 meq/100 g. Typically, the cationic capacity of clays are measured by the method described in Grimshaw, The Chemistry and Physics of Clays, 1971, Interscience Publishers Inc., pages 264-265. Especially preferred Hectorite clays are supplied by Rheox, and sold under the tradenames “Hectorite U” and “Hectorite R”.

The clay may be a light coloured crystalline clay mineral, preferably having a reflectance of at least 60, more preferably at least 70, or at least 80 at a wavelength of 460 nm. Preferred light coloured crystalline clay minerals are china clays, halloysite clays, dioctahedral clays such as kaolinite, trioctahedral clays such as antigorite and amesite, smectite and hormite clays such as bentonite (montmorillonite), beidilite, nontronite, hectorite, attapulgite, pimelite, mica, muscovite and vermiculite clays, as well as pyrophyllite/talc, willemseite and minnesotaite clays. Preferred light coloured crystalline clay minerals are described in GB2357523A and WO01/44425.

The clay is in non-spray-dried form. The clay is typically in the form of a particle, onto which water is sprayed during its production. Typically, the clay is in hydrated form. The clay is preferably in particulate form, wherein the clay particle comprises at least 8 wt % water, preferably at least 10 wt %, 12 wt %, or at least 14 w %, or even at least 16 wt % water.

### Silicate Salt

The composition optionally comprises from 0% to 20 wt % silicate salt, preferably to 15 wt %, or to 10 wt %, or even to 5% silicate salt. It may even be preferred for the composition to be essentially free from silicate salt. By essentially free from silicate salt it is typically meant that the composition comprises no deliberately added silicate. This is especially preferred in order to ensure that the composition has a very good dispensing and dissolution profiles and to ensure that the composition provides a clear wash liquor upon dissolution in water. Silicate salts include water-insoluble silicates. Silicate salts include amorphous silicates and crystalline layered silicates (e.g. SKS-6). A preferred silicate salt is sodium silicate.

### Spray-Dried Powder

The spray-dried powder comprises (i) anionic detersive surfactant; (ii) from 0 wt % to 10 wt % zeolite builder; (iii) from 0 wt % to 10 wt % phosphate builder; and (iv) optionally from 0 wt % to 20 wt % silicate salt. The spray-dried powder is preferably essentially free of clay.

### Non-Spray-Dried Powder

The clay is in the form of a non-spray-dried powder. Other non-spray dried powders may be present in the laundry detergent composition, such as surfactant agglomerates.

### Process

In another embodiment of the present invention, there is provided a process to prepare the composition described above. The process comprises the steps of: (a) contacting water and/or an aqueous liquid and/or aqueous suspension to clay in a mixer to form a hydrated clay; and (b) contacting the hydrated clay with a powder comprising anionic detersive surfactant to form a solid laundry detergent composition. The clay is not spray-dried during this process, although other components, e.g. such as the anionic detersive surfactant, may be spray-dried during this process. At least part of the anionic detersive surfactant is spray-dried during the process.

### EXAMPLES

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

### Example 1

### A Particulate Laundry Detergent Composition and Process of Making it

Aqueous slurry composition.

| | Aqueous slurry |
|---|---|
| Component | (parts) |
| Ethylenediamine disuccinic acid | 0.35 |
| Magnesium sulphate | 0.72 |
| Acrylate/maleate copolymer | 6.45 |
| Linear alkyl benzene sulphonate | 11.92 |
| Hydroxyethane di(methylene phosphonic acid) | 0.32 |
| Sodium carbonate | 4.32 |
| Sodium sulphate | 47.49 |
| Water | 25.89 |
| Miscellaneous | 0.42 |
| Total Parts | 100.00 |

Preparation of a Spray-Dried Powder.

An aqueous slurry having the composition as described above is prepared having a moisture content of 25.89%. The aqueous slurry is heated to 72° C. and pumped under high pressure (from 5.5×10⁶ Nm⁻² to 6.0×10⁶ Nm⁻²), into a counter-current spray-drying tower with an air inlet temperature of from 270° C. to 300° C. The aqueous slurry is atomised and the atomised slurry is dried to produce a solid mixture, which is then cooled and sieved to remove oversize material (>1.8 mm) to form a spray-dried powder, which is free-flowing. Fine material (<0.15 mm) is elutriated with the exhaust air in the spray-drying tower and collected in a post tower containment system. The spray-dried powder has a moisture content of 2.5 wt %, a bulk density of 427 g/l and a particle size distribution such that 95.2 wt % of the spray-dried powder has a particle size of from 150 to 710 micrometers. The composition of the spray-dried powder is given below.

Spray-dried powder composition.

| | % w/w |
|---|---|
| | Spray-dried |
| Component | powder |
| Magnesium sulphate | 0.96 |
| Acrylate/maleate copolymer | 8.62 |
| Linear alkyl benzene sulphonate | 15.92 |
| Hydroxyethane di(methylene phosphonic acid) | 0.43 |
| Sodium carbonate | 5.77 |
| Sodium sulphate | 63.43 |
| Water | 2.5 |
| Miscellaneous | 0.55 |
| Total Parts | 100.00 |

### Preparation of a Hydrated Clay Particle

800 g batch non-spray dried montmorillonite clay is filled into a Tilt-A-Pin mixer. 150 g water at 26° C. is slowly added to the clay batch while the content is mixed at 1200 rpm for 15 seconds. The result is a mixture of hydrated clay free flowing particles. The composition of the clay particle is: 84 wt % montmorillonite clay, 16 wt % water.

A granular laundry detergent composition.

| | % w/w |
|---|---|
| | granular |
| | laundry |
| | detergent |
| Component | composition |
| Spray-dried powder of example 1 (described above) | 59.38 |
| 91.6 wt % active linear alkyl benzene sulphonate | 0.22 |
| flake supplied by Stepan under the tradename | |
| Nacconol 90G ® | |
| Citric acid | 5.00 |
| Sodium percarbonate (having from 12% to 15% | 14.70 |
| active AvOx) | |
| Photobleach particle | 0.01 |
| Lipase (11.00 mg active/g) | 0.70 |
| Amylase (21.55 mg active/g) | 0.33 |
| Protease (56.00 mg active/g) | 0.43 |
| Tetraacetyl ethylene diamine agglomerate (92 wt % active) | 4.35 |
| Suds suppressor agglomerate (11.5 wt % active) | 0.87 |
| Acrylate/maleate copolymer particle (95.7 wt % active) | 0.29 |
| Green/Blue carbonate speckle | 0.50 |
| Sodium Sulphate | 6.27 |
| Clay particle of example 1 (described above) | 6.32 |
| Solid perfume particle | 0.63 |
| Total Parts | 100.00 |

The above laundry detergent composition was prepared by dry-mixing all of the above particles in a standard batch mixer.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”.

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A solid laundry detergent composition comprising:
(a) anionic detersive surfactant;
(b) from 0 wt % to 10 wt % zeolite builder;
(c) from 0 wt % to 10 wt % phosphate builder;
(d) at least 2 wt % water;
(e) clay; and
(f) optionally from 0 wt % to 20 wt % silicate salt,
wherein the clay is in non-spray-dried form, and wherein at least part of the anionic detersive surfactant is in spray-dried form.

2. A composition according to claim 1, wherein the clay is in particulate form, and wherein the clay particle comprises at least 12 wt % water.

3. A composition according to claim 1, wherein the composition comprises montmorillonite clay.

4. A composition according to claim 1, wherein the composition comprises from 1 wt % to 10 wt % clay.

5. A composition according to claim 1, wherein the composition comprises:
(a) spray-dried powder comprising:
(i) anionic detersive surfactant;
(ii) from 0 wt % to 10 wt % zeolite builder;
(iii) from 0 wt % to 10 wt % phosphate builder; and
(iv) optionally from 0 wt % to 20 wt % silicate salt; and
(b) non-spray-dried powder comprising clay.

6. A process to prepare a composition according to claim 1, wherein the process comprises the steps of:
(a) contacting water and/or an aqueous liquid and/or aqueous suspension to clay, wherein the clay is in non-spray-dried form, to form a hydrated clay; and
(b) contacting the hydrated clay with a powder comprising anionic detersive surfactant to form a solid laundry detergent composition.
